(19) United States
(12) Patent Application Publication
(10) Pub. No.: US 2012/0114256 A1
(43) Pub. Date: May 10, 2012

(54) RELEVANCE FEEDBACK FOR CONTENT-BASED IMAGE RETRIEVAL

(75) Inventors: Ceyhun Burak Akgul, Istanbul (TR); Ahmet Ekin, Eindhoven (NL)

(73) Assignee: KONINKLIJKE PHILIPS ELECTRONICS N.V., EINDHOVEN (NL)

(21) Appl. No.: 13/380,951

(22) PCT Filed: Jun. 23, 2010
(86) PCT No.: PCT/IB2010/052845

§ 371 Date: Dec. 27, 2011

(30) Foreign Application Priority Data
Jun. 30, 2009 (EP) 09164122.5

(51) Int. Cl. G06K 9/68

(52) U.S. Cl. 382/218

(57) ABSTRACT

The invention relates to a system (100) for retrieving an image from image storage means, the system comprising: a retrieval unit (110) for retrieving a plurality of images from image storage means, on the basis of similarity between said images from image storage means and a query image, wherein the similarity is defined by a similarity function, and comprising a relevance unit (120) for computing values of relevance of images of the retrieved plurality of images on the basis of a value of a first attribute relating to the query image and values of a second attribute relating to the images of the retrieved plurality of images, and an update unit (130) for updating the similarity function on the basis of the computed values of relevance, and wherein the retrieval unit (110) is further adapted for retrieving the image from image storage means on the basis of the updated similarity function. The values of the first and second attributes are used by the retrieval unit to compute relevance values (e.g. ranks) of the plurality of images retrieved from image storage means. The user is thus relieved of the task of comparing the retrieved images and evaluating their relevance according to a user-defined criterion. Advantageously, the relevance values computed by the system are less dependent on, or independent of, user subjectivity. Optionally, the system may further comprise a prediction unit (140) for predicting the value of an attribute relating to the query image, on the basis of the image retrieved by the retrieval unit (110) using the similarity function updated by the update unit (130)

### FIELD OF THE INVENTION

The invention relates to content-based image retrieval and, more particularly, to improving content-based image retrieval using relevance computation. In an aspect the invention further relates to making predictive hypotheses, especially predictive diagnostic hypotheses, on the basis of image retrieval.

### BACKGROUND OF THE INVENTION

Radiologists face an ever-increasing workload resulting from an ever-increasing number of images to be analyzed, classified and/or described. Retrieving images stored in storage of old images, which describe old cases affected by a certain disease, and which are similar to a new image describing a new case on the basis of similarity between the new image and images stored in said storage of old images, may be very helpful in diagnosing the new case. Content-based image retrieval (CBIR) has become an important technique for retrieving images. In this approach, each image is represented by a structure describing image features, e.g. a feature vector. A similarity function (SF) computes the similarity value based, for example, on the length of the difference between the two vectors: the shorter the difference between the two feature vectors, the greater the similarity between the two images.

A drawback of the CBIR methods is described in an article by Rui et al. “Relevance Feedback: A Power Tool for Interactive Content-Based Image Retrieval” (IEEE Transaction on Circuits and System for Video Technology, vol. 6 Sep. 1998, pp. 644-655): such systems tend to be computer-centric because the image feature vector typically comprises low level features which often do not correspond to human perception determined by high level concepts. The solution proposed by Rui et al. is to classify features as useful or not/less useful on the basis of user feedback. To this end the user is asked to rank the images, retrieved on the basis of the similarity of the feature vector, from highly relevant to non-relevant. A feature is considered relevant when the values of this feature in the new image and in retrieved images classified as highly relevant are very similar or if the values of this feature in the new image and in retrieved images classified as non-relevant are very different. Relevant features are then used to redefine the SF for CBIR. This is achieved by assigning higher weights to SF terms corresponding to highly relevant features and lower weights to SF terms corresponding to non-relevant features. While the method of Rui et al. improves the CBIR, it requires interactive ranking of retrieved images by the user. This is inconvenient and may be time-consuming.

### SUMMARY OF THE INVENTION

It would be advantageous to provide CBIR which does not require interactive ranking of retrieved images by the user.

Thus, in an aspect, the invention provides a system for retrieving an image from image storage means, the system comprising

a retrieval unit for retrieving a plurality of images from image storage means, on the basis of similarity of images from image storage means to a query image, wherein the similarity is defined by a similarity function;

a relevance unit for computing values of relevance of images of the retrieved plurality of images on the basis of a value of a first attribute relating to the query image and values of a second attribute relating to the images of the retrieved plurality of images; and

an update unit for updating the similarity function on the basis of the computed values of relevance;

and wherein the retrieval unit (110) is further adapted for retrieving the image from image storage means, based on the updated similarity function.

The values of the second attribute may be stored in and obtained from image storage means. The second attribute may be, for example, a test performed on patients which are imaged in part or in whole in the stored images. The values may represent, for example, results of the test, such as heart rate measurement, blood pressure measurement, or clinical dementia rating (CDR). Alternatively, the values of the second attribute, e.g., the mean grey value of the image pixels, may be computed from the respective images. The value of the first attribute relating to the query image may be, for example, stored in the query image data (e.g. within an image header), or derived from the query image or from a user input by the relevance unit. These values of the first and second attributes are used by the retrieval unit to compute relevance values (e.g. ranks) of the plurality of images retrieved from image storage means. The user is thus relieved of the task of comparing the retrieved images and evaluating their relevance according to a user-defined criterion. Advantageously, the relevance values computed by the system are less dependent on, or independent of, user subjectivity.

In an embodiment of the system, the similarity function comprises multiple contributions for computing a similarity value, and the update unit is further arranged to select certain contributions of the multiple contributions to be included in the updated similarity function. For example, a feature may be considered relevant when the values of this feature in the new image and in retrieved images classified as highly relevant are similar or if the values of this feature in the new image and in retrieved images classified as non-relevant are quite different.

In an embodiment of the system, values of the second attribute, each value corresponding to an image from image storage means, are stored in image storage means. The values of the second attribute may be obtained based on a user evaluation of the image, a test performed on an object pictured in the image, or computed from the image. Having values of the second attribute readily available in the image storage means allows calculating the relevance of the plurality of images retrieved from the image storage means on the basis of the second attribute without any user interaction. Alternatively, values of the second attribute, e.g. the mean of pixel values or the diameter of the largest circle contained in a model of an object adapted to the object pictured in the image using model-based segmentation, relating to the images of the plurality of images may be computed based on the plurality of images.

In an embodiment of the system, the value of the first attribute is computed on the basis of a user input. The user input may comprise the value of the first attribute, in which case the computation assigns the inputted value to the first attribute value. In a more elaborate case, the user input may comprise a gray value and the first attribute is the percentage of pixels having pixel values greater than the inputted gray value.

In an embodiment of the system, the first attribute is the same as the second attribute. This often simplifies the computation of the relevance of images of the retrieved plurality of images on the basis of a value of a first attribute relating to the query image and values of a second attribute relating to the images of the retrieved plurality of images. If for an image of the plurality of retrieved images a value of the second attribute is similar to the value of the first attribute, the image is assigned a high value of relevance.

In an embodiment of the system, the first and second attribute is a hypothesis that, respectively, the query image and the images from the image storage means satisfy a condition. Thus, the relevance of an image of the retrieved plurality of images is considered high if the hypothesis relating to the query image and the hypothesis relating to the image of the retrieved plurality of images are both true, i.e. have the same logical value.

In an embodiment of the system, the value of the first attribute is computed on the basis of a user input, and the user input is a probability that the hypothesis is true. The relevance unit is arranged to compute the logical value of the hypothesis, using a statistical test as disclosed in more detail in the description of embodiments.

In an embodiment of the system, the hypothesis is a diagnostic hypothesis. The hypothesis may be a diagnostic statement relating to a patient whose body or body part is pictured in the image. The system is thus adapted for retrieving images with similar diagnostic statements. Such diagnostic application of the system of the invention is suitable for helping physicians arrive at a diagnosis.

In an embodiment, the system further comprises a prediction unit for predicting the value of an attribute relating to the query image on the basis of the image retrieved by the retrieval unit using the similarity function updated by the update unit. For example, the diagnostic statement relating to the retrieved image with the highest similarity value may be applied by the prediction unit to the query image. In another application, the diagnostic statement most frequently occurring among a number of the most similar images may be applied to the query image.

In a further aspect, the system according to the invention is comprised in a database system. The database comprises the image storage means with image data. In addition, the database may store other data such as values of the second attribute for some or all images comprised in the database. The system of the invention improves the searching capabilities of the database and expands its functions.

In a further aspect, the system according to the invention is comprised in an image acquisition apparatus.

In a further aspect, the system according to the invention is comprised in a workstation.

In a further aspect, the invention provides a method of retrieving an image from image storage means, the system comprising:

a retrieval step for retrieving a plurality of images from the image storage means similar to a query image, on the basis of similarity of images from the image storage means to a query image, defined by a similarity function;

a relevance step for computing values of relevance of images of the retrieved plurality of images on the basis of a value of a first attribute of the query image and values of a second attribute of the images of the retrieved plurality of images; and

an update step for updating the similarity function at least on the basis of the computed values of relevance;

and wherein the retrieval unit (110) is further adapted for retrieving the image from the image storage means, based on the updated similarity function.

In a further aspect, the invention provides a computer program product to be loaded by a computer arrangement, the computer program comprising instructions for retrieving an image from image storage means, the computer arrangement comprising a processing unit and a memory, the computer program product, after being loaded, providing said processing unit with the capability to carry out steps of the method.

It will be appreciated by those skilled in the art that two or more of the above-mentioned embodiments, implementations, and/or aspects of the invention may be combined in any way deemed useful.

Modifications and variations of the system, the database system, of the image acquisition apparatus, of the workstation, of the method, and/or of the computer program product, which correspond to the described modifications and variations of the system or the method, can be carried out by a person skilled in the art on the basis of the present description.

A person skilled in the art will appreciate that the method may be applied to multidimensional image data, e.g., 2-dimensional (2-D), 3-dimensional (3-D) or 4-dimensional (4-D) image data, acquired by various acquisition modalities such as, but not limited to, X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

The invention is defined by the independent claims. Advantageous embodiments are defined in the dependent claims.

### BRIEF DESCRIPTION OF THE DRAWINGS

These and other aspects of the invention will become apparent from and will be elucidated with respect to the implementations and embodiments described hereinafter and with reference to the accompanying drawings, wherein:

FIG. 1 shows a block diagram of an exemplary embodiment of the system;

FIG. 2 shows a schematic description of a diagnostic protocol according to the invention;

FIG. 3 shows a flowchart of exemplary implementations of the method;

FIG. 4 schematically shows an exemplary embodiment of the database system; and

FIG. 5 schematically shows an exemplary embodiment of the image acquisition apparatus; and

FIG. 6 schematically shows an exemplary embodiment of the workstation.

Identical reference numerals are used to denote similar parts throughout the Figures.

### DETAILED DESCRIPTION OF EMBODIMENTS

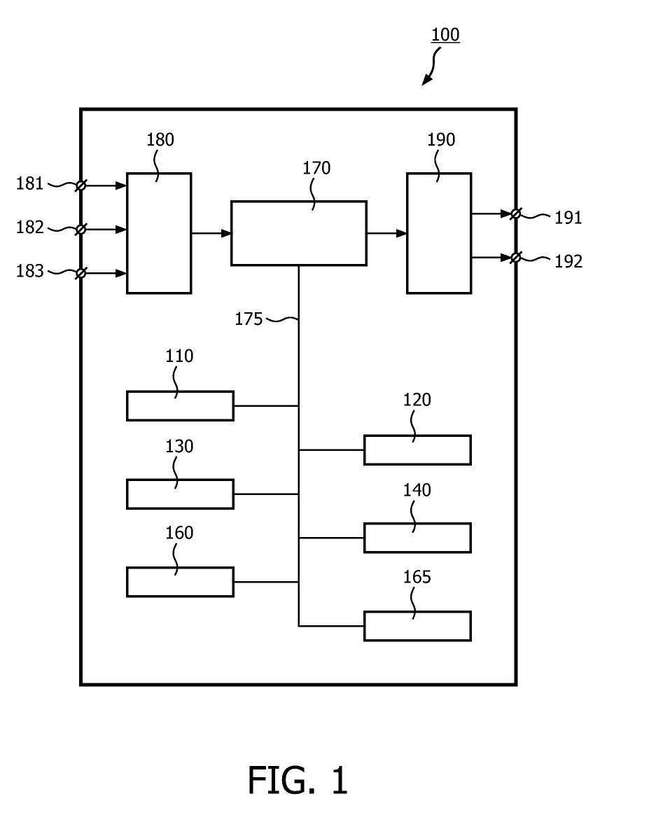

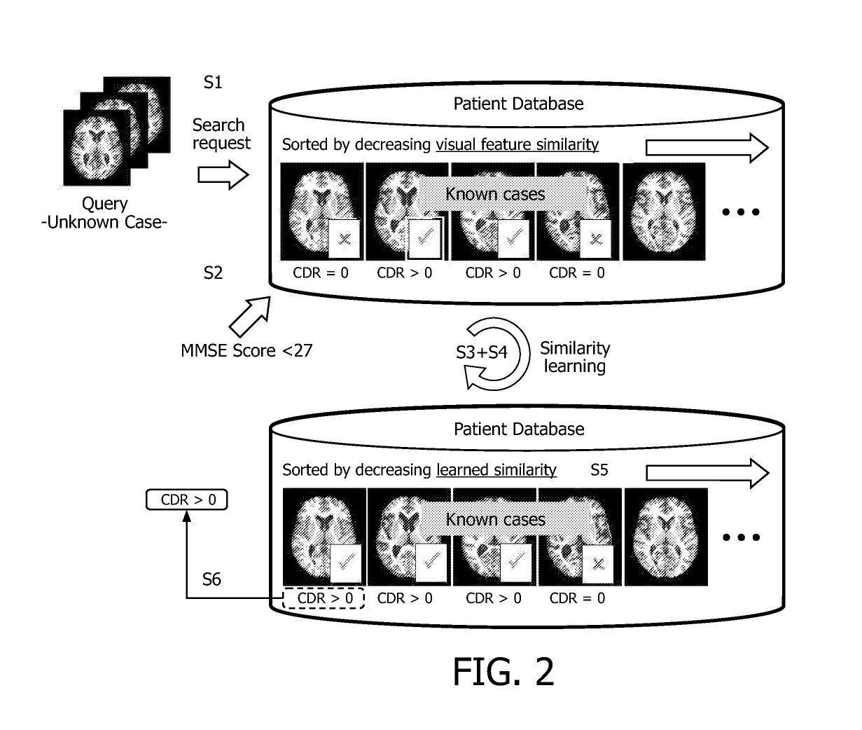

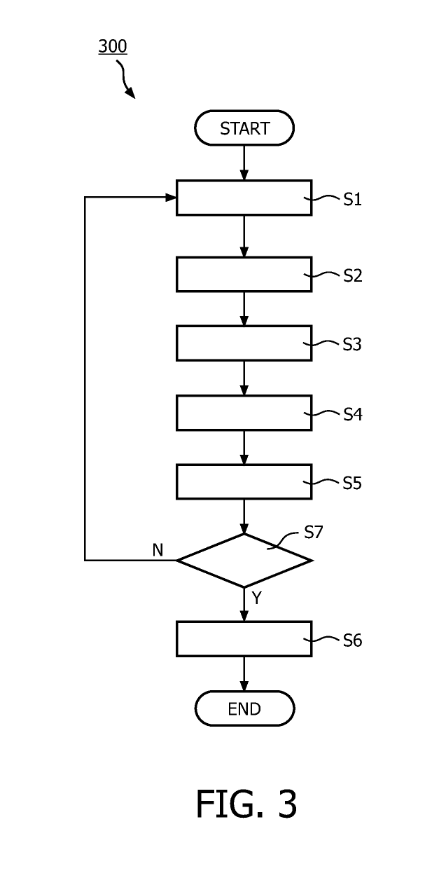

FIG. 1 schematically shows a block diagram of an exemplary embodiment of the system 100 for retrieving an image from image storage means, the system comprising

a retrieval unit 110 for retrieving a plurality of images from image storage means, on the basis of similarity of images from said image storage means to a query image, wherein the similarity is defined by a similarity function;

a relevance unit 120 for computing values of relevance of images of the retrieved plurality of images on the basis of a value of a first attribute relating to the query image and values of a second attribute relating to the images of the retrieved plurality of images; and

an update unit 130 for updating the similarity function on the basis of the computed values of relevance;

and wherein the retrieval unit (110) is further adapted for retrieving the image from image storage means, based on the updated similarity function.

The exemplary embodiment of the system 100 further comprises a prediction unit 140 for predicting the value of an attribute relating to the query image, on the basis of the image retrieved by the retrieval unit 110, using the similarity function updated by the update unit 130;

a control unit 160 for controlling the work of the system 100;

a user interface 165 for communication between the user and the system 100; and

a memory unit 170 for storing data.

In an embodiment of the system 100, there are three input connectors 181, 182 and 183 for the incoming data. The first input connector 181 is arranged to receive data coming in from a data storage means such as, but not limited to, a hard disk, a magnetic tape, a flash memory, or an optical disk. The second input connector 182 is arranged to receive data coming in from a user input device such as, but not limited to, a mouse or a touch screen. The third input connector 183 is arranged to receive data coming in from a user input device such as a keyboard. The input connectors 181, 182 and 183 are connected to an input control unit 180.

In an embodiment of the system 100, there are two output connectors 191 and 192 for the outgoing data. The first output connector 191 is arranged to output the data to a data storage means such as a hard disk, a magnetic tape, a flash memory, or an optical disk. The second output connector 192 is arranged to output the data to a display device. The output connectors 191 and 192 receive the respective data via an output control unit 190.

A person skilled in the art will understand that there are many ways to connect input devices to the input connectors 181, 182 and 183 and the output devices to the output connectors 191 and 192 of the system 100. These ways comprise, but are not limited to, a wired and a wireless connection, a digital network such as, but not limited to, a Local Area Network (LAN) and a Wide Area Network (WAN), the Internet, a digital telephone network, and an analog telephone network.

In an embodiment of the system 100, the system 100 comprises a memory unit 170. The system 100 is arranged to receive input data from external devices via any of the input connectors 181, 182, and 183 and to store the received input data in the memory unit 170. Loading the input data into the memory unit 170 allows quick access to relevant data portions by the units of the system 100. The input data comprises the query image. Optionally, the input data comprises image data from image storage means. Alternatively, image storage means may be implemented by the memory 170. Further, the input data may comprise a user input and/or values of the second attribute of images comprised in image storage means. The memory unit 170 may be implemented by devices such as, but not limited to, a register file of a CPU, a cache memory, a Random Access Memory (RAM) chip, a Read Only Memory (ROM) chip, and/or a hard disk drive and a hard disk. The memory unit 170 may be further arranged to store the output data. The output data comprises the image retrieved by the retrieval unit 110. The output data may also comprise, for example, useful information about the updated similarity function and the predicted value of an attribute relating to the query image. The memory unit 170 may be also arranged to receive data from and/or deliver data to the units of the system 100 comprising the retrieval unit 110, the relevance unit 120, the update unit 130, the prediction unit 140, the control unit 160, and the user interface 165, via a memory bus 175. The memory unit 170 is further arranged to make the output data available to external devices via any of the output connectors 191 and 192. Storing data from the units of the system 100 in the memory unit 170 may advantageously improve performance of the units of the system 100 as well as the rate of transfer of the output data from the units of the system 100 to external devices.

In an embodiment of the system 100, the system 100 comprises a control unit 160 for controlling the system 100. The control unit may be arranged to receive control data from and provide control data to the units of the system 100. For example, after updating the similarity function, the update unit 130 may be arranged to provide control data “the similarity function is updated” to the control unit 160 and the control unit 160 may be arranged to provide control data “retrieve the image” to the retrieval unit 110. Alternatively, a control function may be implemented in another unit of the system 100.

In an embodiment of the system 100, the system 100 comprises a user interface 165 for communication between a user and the system 100. The user interface 165 may be arranged to receive a user input for downloading a query image into the memory 170 or for computing the value of the first attribute. The user interface may further provide means for displaying the plurality of images retrieved by the retrieval unit 110. Optionally, the user interface may receive a user input for selecting a mode of operation of the system such as, e.g., for a method of updating the similarity function. A person skilled in the art will understand that more functions may be advantageously implemented in the user interface 165 of the system 100.

In an embodiment, the system 100 of the invention is adapted for predicting elaborate cognitive test scores from basic test scores. To give an example, the mini-mental state examination (MMSE) is a brief commonly used questionnaire, where a score over 27 (out of 30) is effectively considered as normal, while lower scores increasingly correlate with presence of dementia. While this test can be completed in just five minutes, it has been observed that putting a simple threshold at 27 (out of 30) usually falls short in detecting the presence of dementia. The clinical dementia rating (CDR), on the other hand, is a much more elaborate, but also time-consuming test, credited with being able to discern even mild levels of dementia with great accuracy. A CDR score of 0 indicates no dementia, while higher scores show dementia of increasing severity. Each image of the database is assigned a CDR.

The approach is based on first retrieving past cases that are visually similar to an unknown new case, then labeling a few of them as relevant or irrelevant using simple test scores, and finally automatically learning a novel adaptive similarity measure that can more accurately probe the absence or presence of a certain condition. The protocol proposed in this invention is illustrated in FIG. 1 and consists of the following steps:

(S1) The user enters the new case (query image) to the system 100; the retrieval unit 110 returns a ranked list of past cases (database images) based on visual similarity (e.g., measured as the affinity between intensity histograms of MR images).
(S2-1) A hypothesis on the query is automatically generated based on the MMSE score of the new case, which may be included in the header of the query image data or may be inputted by the user, for example.
(S3-1) Relevance values (e.g. Boolean values TRUE or FALSE) based on relevance relations between the query image and as many database images as one wants are computed by the relevance unit 120 using the formula: relevance=(MMSE<27) AND (CDR>0). The number M of database images for which the relevance is computed can be specified by the user or can be fixed based on performance benchmarking.
(S4) Previous steps output (relevance values for each of the M database images) is used by the update unit 130 as a training set; it consist of M images; based on this set, the similarity function is updated using machine learning.
(S5) Using this updated similarity function, the retrieval unit 110 returns a new list of database images ranked according to the values of the updated similarity function.
(S6-1) Finally, the CDR score relating to the query predicted by the prediction unit 140 is the CDR score of the top image of the ranked list retrieved in step S5.

In another embodiment, the system 100 of the invention is adapted for assisting a physician in diagnosing mental disorders, using image similarity and uncertain user hypothesis. Each image of the database is assigned a diagnosis. The steps of the algorithm are:

(S1) The user enters the new case (query image) to the system 100; the retrieval unit 110 returns a ranked list of past cases (database images) based on visual similarity (e.g., measured as the affinity between intensity histograms of MR images).
(S2-2) The user provides a diagnostic hypothesis on the query image and/or an associated confidence statement (the latter could be done via verbal statements or via adjusting a slider on the user interface, for example).
(S3-2) The diagnostic hypothesis is tested based on the confidence statement, e.g. a probability p that the diagnostic hypothesis is true. For example, a random number r is generated using a generator of random numbers uniformly distributed on the interval [0, 1]. If r≦p then the test outcome is TRUE (i.e. the diagnostic hypothesis is true); otherwise the outcome is FALSE (i.e. the diagnostic hypothesis is false). Relevance values (e.g. Boolean values TRUE or FALSE), based on the outcome of the diagnostic hypothesis testing and on whether (hypothesis<=diagnosis) for each of the M retrieved images, are computed according to the formula: relevance=(test outcome) AND (hypothesis<=diagnosis). The number M can be specified by the user or can be determined based on performance benchmarking.
(S4) Previous steps output (relevance values for each of the M database images) is used by the update unit 130 as a training set; it consist of M images; based on this set, the similarity function is updated using machine learning.
(S5) Using this updated similarity function, the retrieval unit 110 returns a new list of database images ranked according to the values of the updated similarity function.
(S6-2) Finally, the diagnosis relating to the query predicted by the prediction unit 140 is the diagnosis relating to the top image of the ranked list retrieved in step S5.

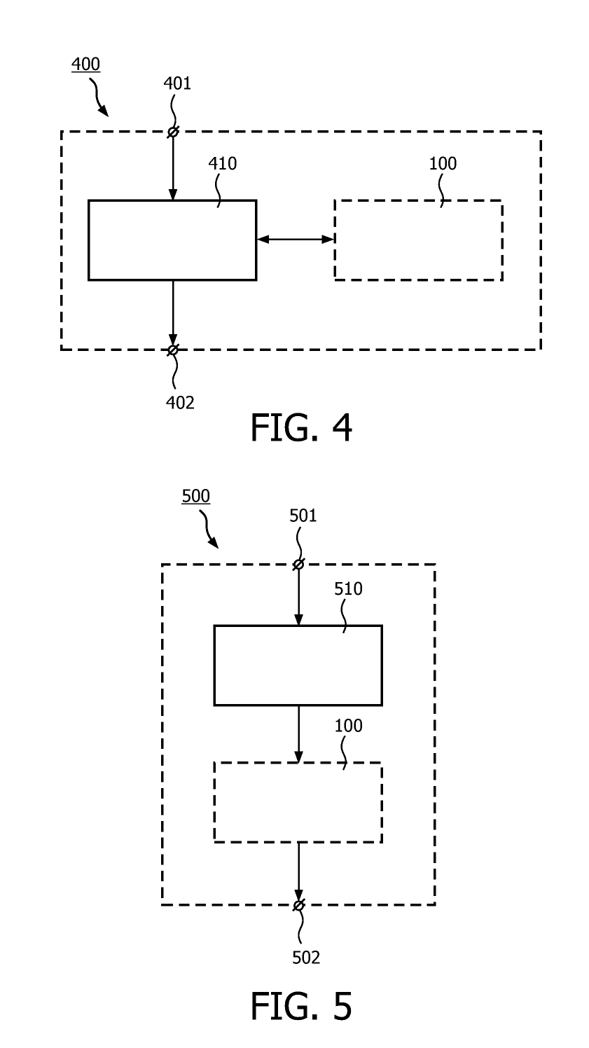

A flowchart of both exemplary implementations of the method M of retrieving an image from image storage means is schematically shown in FIG. 5. A person skilled in the art may change the order of some steps or perform some steps concurrently using threading models, multi-processor systems or multiple processes without departing from the concept as intended by the present invention. Optionally, two or more steps of the method M may be combined into one step. Optionally, a step of the method M may be split into a plurality of steps. Optionally, the method M may further comprise an iteration step S7 for checking a condition. The condition may be based on a user input. If the condition is satisfied, the method M is arranged for repeating steps S1 to S5 to further update the similarity function. If the condition is not satisfied, the method M continues to the last step S6 and then terminates.

A person skilled in the art will understand that “image” typically refers to a 2D or 3D image. Alternatively, “image” may also stand for an object such as but not limited to a string of characters or a symbol.

In an embodiment, the similarity function is determined in step S4 by the update unit 130 in the following manner. Let q=(qₖ)εR^{K} denote a K-dimensional image feature vector of the query and let x^{m}=(xₖ^{m})εR^{K}, m=1, 2, . . . , M denote an image feature vector of the m-th image from the plurality of images retrieved by the retrieval unit 110 in step S1. The contribution of the k-th image feature has a weight wₖ of a weight vector w. The similarity function for computing the similarity of the retrieved image described by the feature vector x to the query image described by the feature vector q may be defined as

$$S ( q , x ) = {\sum }_{k = 1}^{K} {w}_{k} exp ( - \vert {q}_{k} - {x}_{k} \vert )$$

A person skilled in the art will know many ways of computing values wₖ based on the feature vectors x^{m} corresponding to the plurality of images retrieved by the retrieval unit 110 and the relevance values y^{m} computed by the relevance unit 120. Any suitable method can be implemented in the update step S4 and employed by the update unit 130. For example, the weights can be computed using Rui's method described in the aforementioned paper by Rui et al., or using machine learning. Suitable machine-learning methods are described, for example, in Chapter 3 of C. B. Akgul's work entitled “Density-based shape descriptors and similarity learning for 3D object retrieval”, PhD Thesis, Telecom ParisTech and Bogazici University, 2007. Further, the references cited in this work may be helpful to understand the statistical learning of similarity described in said Chapter 3. A person skilled in the art will understand that the scope of the claims is not limited by the definition of the similarity function or by the method employed for updating the similarity function parameters such as the weights wₖ in the exemplary embodiment described above.

A person skilled in the art will appreciate that the system 100 may be a valuable tool for assisting a physician in many aspects of her/his job. Further, although the embodiments of the system are illustrated using medical applications of the system, non-medical applications of the system are also contemplated.

Those skilled in the art will further understand that other embodiments of the system 100 are also possible. It is possible, among other things, to redefine the units of the system and to redistribute their functions. Although the described embodiments apply to medical images, other applications of the system, not related to medical applications, are also possible.

The units of the system 100 may be implemented using a processor. Normally, their functions are performed under the control of a software program product. During execution, the software program product is normally loaded into a memory, like a RAM, and executed from there. The program may be loaded from a background memory, such as a ROM, hard disk, or magnetic and/or optical storage, or may be loaded via a network like the Internet. Optionally, an application-specific integrated circuit may provide the described functionality.

FIG. 4 schematically shows an exemplary embodiment of the database system 400 employing the system 100 of the invention, said database system 400 comprising a database unit 410 connected via an internal connection to the system 100, an external input connector 401, and an external output connector 402. This arrangement advantageously increases the capabilities of the database system 400, providing said database system 400 with advantageous capabilities of the system 100.

FIG. 5 schematically shows an exemplary embodiment of the image acquisition apparatus 500 employing the system 100 of the invention, said image acquisition apparatus 500 comprising an image acquisition unit 510 connected via an internal connection with the system 100, an input connector 501, and an output connector 502. This arrangement advantageously increases the capabilities of the image acquisition apparatus 500, providing said image acquisition apparatus 500 with advantageous capabilities of the system 100.

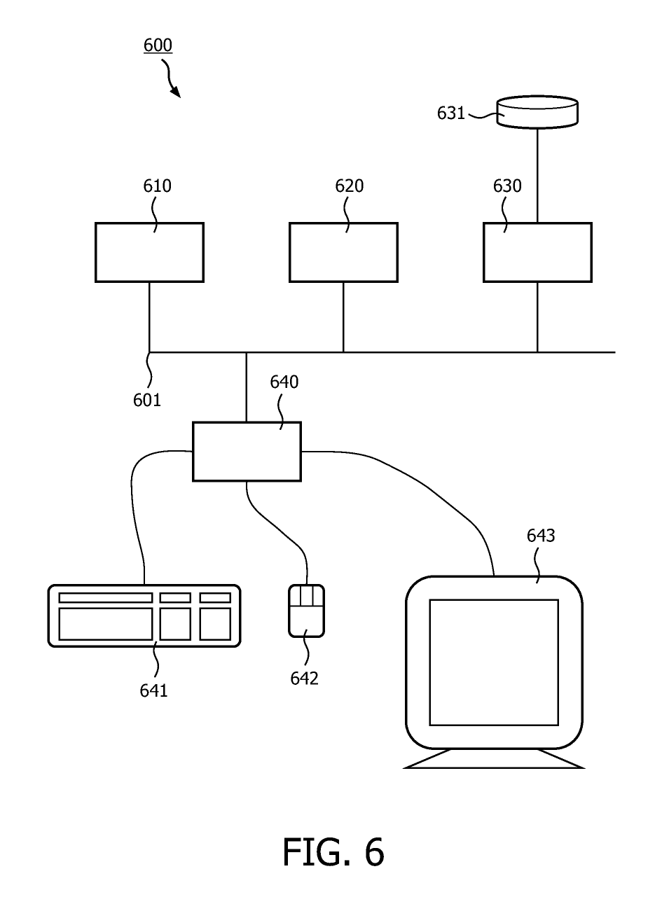

FIG. 6 schematically shows an exemplary embodiment of the workstation 600. The workstation comprises a system bus 601. A processor 610, a memory 620, a disk input/output (I/O) adapter 630, and a user interface (UI) 640 are operatively connected to the system bus 601. A disk storage device 631 is operatively coupled to the disk I/O adapter 630. A keyboard 641, a mouse 642, and a display 643 are operatively coupled to the UI 640. The system 100 of the invention, implemented as a computer program, is stored in the disk storage device 631. The workstation 600 is arranged to load the program and input data into memory 620 and execute the program on the processor 610. The user can input information to the workstation 600, using the keyboard 641 and/or the mouse 642. The workstation is arranged to output information to the display device 643 and/or to the disk 631. A person skilled in the art will understand that there are numerous other embodiments of the workstation 600 known in the art and that the present embodiment serves the purpose of illustrating the invention and must not be interpreted as limiting the invention to this particular embodiment.

It should be noted that the above-mentioned embodiments illustrate rather than limit the invention and that those skilled in the art will be able to design alternative embodiments without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. The invention can be implemented by means of hardware comprising several distinct elements and by means of a programmed computer. In the system claims enumerating several units, several of these units can be embodied by one and the same record of hardware or software. The usage of the words first, second, third, etc., does not indicate any ordering. These words are to be interpreted as names.

1. A system (100) for retrieving an image from image storage means, the system comprising
a retrieval unit (110) for retrieving a plurality of images from image storage means, on a basis of similarity of images from said image storage means to a query image, wherein the similarity is defined by a similarity function;
a relevance unit (120) for computing values of relevance of images of the retrieved plurality of images on a basis of a value of a first attribute relating to the query image and values of a second attribute relating to the images of the retrieved plurality of images; and
an update unit (130) for updating the similarity function on a basis of the computed values of relevance;
and wherein the retrieval unit (110) is further adapted for retrieving the image from image storage means, based on the updated similarity function.

2. A system (100) as claimed in claim 1, wherein the similarity function comprises multiple contributions for computing a similarity value, and wherein the update unit (130) is further arranged to select certain contributions of the multiple contributions to be included in the updated similarity function.

3. A system (100) as claimed in claim 1, wherein values of the second attribute, each value corresponding to an image from image storage means, are stored in said image storage means.

4. A system (100) as claimed in claim 1, wherein the value of the first attribute is computed on the basis of a user input.

5. A system (100) as claimed in claim 1, wherein the first attribute is the same as the second attribute.

6. A system (100) as claimed in claim 5, wherein the first and the second attribute is a hypothesis that, respectively, the query image and the images from image storage means satisfy a condition.

7. A system (100) as claimed in claim 6, wherein the value of the first attribute is computed on the basis of a user input, and wherein the user input is a probability that the hypothesis is true.

8. A system (100) as claimed in claim 6, wherein the hypothesis is a diagnostic hypothesis.

9. A system (100) as claimed in claim 1, further comprising a prediction unit (140) for predicting the value of an attribute relating to the query image on the basis of the image retrieved by the retrieval unit (110), using the similarity function updated by the update unit (130).

10. A database system (400) comprising a system (100) as claimed in claim 1.

11. An image acquisition apparatus (500) comprising a system (100) as claimed in claim 1.

12. A workstation (600) comprising a system (100) as claimed in claim 1.

13. A method (M) of retrieving an image from image storage means, the system comprising
a retrieval step (S1) for retrieving a plurality of images from image storage means similar to a query image, on a basis of similarity of images from image storage means to a query image, defined by a similarity function;
a relevance step (S3) for computing values of relevance of images of the retrieved plurality of images on a basis of a value of a first attribute of the query image and values of a second attribute of the images of the retrieved plurality of images; and
an update step (S5) for updating the similarity function at least on a basis of the computed values of relevance;
and wherein the retrieval unit (110) is further adapted for retrieving the image from image storage means, based on the updated similarity function.

14. A method (M) as claimed in claim 13, further comprising a prediction step (S6) for predicting the value of the first attribute relating to the query image on the basis of the image retrieved by the retrieval unit (110), using the similarity function updated by the update unit (130).

15. A computer program product to be loaded by a computer arrangement, comprising instructions for retrieving an image from image storage means, the computer arrangement comprising a processing unit and a memory, the computer program product, after being loaded, providing said processing unit with the capability to carry out steps of a method as claimed in claim 13.
